(19) United States
(12) Patent Application Publication
(10) Pub. No.: US 2003/0159626 A1
(43) Pub. Date: Aug. 28, 2003

(54) Article for manufacturing of marble concrete and process for making same which produces a product of high strength and durability

(76) Inventor: Benjamin Childress, Kansas City, MO (US)

Correspondence Address: Ben Childress III, P.O. Box 482265, Kansas City, MO, 64148, US

(21) Appl. No.: 10/081,684

(22) Filed: Feb. 25, 2002

(51) Int. Cl. C04B 14/00

(52) U.S. Cl. 106/817; 106/738

(57) ABSTRACT

An article for manufacture of marble concrete with use of a specific marble rock unique to certain geographic regions, and process for which rock is removed and thus eliminates stress on rock composition, providing a concrete blend or as an additive. The marble rock may require reformulation depending on the process of normal concrete manufacture process, methods or other generally accepted uses or product classification

### BACKGROUND OF THE INVENTION

This invention relates generally to the field of aggregate compounds and more particularly to an article for manufacture of marble concrete and process for making same which produces high strength, absorption and versatility.

By performing extensive testing on specific marble rock from certain geographic regions, locations and sites and blending complete marble products as aggregate and for concrete, the process for a marble mix to any generally accepted product on the market. In absorption rate, PSI strength, water resistance and setting times. another added benefit is that specific marble can be heated or killed for the manufacture of the marble concrete product. Cement historically has been blended using readily available rock and aggregate products such as limestone, sand, and other aggregate. The properties of the concrete are changed by different quarrying, mining and blending procedures and various killing or heating processes which can improve the durability, absorption and hardness of the concrete. prior compounds and processes do not have durability or the PSI strength of the marble concrete. Typically aggregate rock does not provide as high of absorption properties as the marble. marble rock is water resistant as well as acid resistant.

### SUMMARY OF THE INVENTION

The primary object of the invention is to provide an improved method of manufacture which may require heat or no heat, kilning or without kilning process to form marble concrete

Another object of the invention is specific marble has an improved absorption rate compared to industry standard.

Another object of the invention and this product when removing was not to be stressed by using explosives. creating a stronger product.

Yet another object of the invention is product provides a higher PSI properties, then generally accepted aggregates

Another object of the invention is product is acid resistant.

Another object of the invention is product is water resistant

Another object of the invention it has a stronger and adhering properties.

An article for manufacture of marble concrete comprising: use of a specific types of marble rock unique to certain geographic regions, which when blended will yield a marble concrete product made of marble or marble used for other added value.

A process for comprising the steps of: removing marble rock without compromising the strength factors of the rock.

It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article for manufacture of marble concrete comprising:
use of a specific marble rock unique to certain geographic regions, locations and the process for which rock is removed and thus eliminates stress on rock composition.

2. The invention of claim 1 compromising the further step of locating specific marble rock unique to geographic regions, locations are different from site to site

3. The invention of claim 2 which further compromising the successive test of specific properties the marble rock and its additives or products

4. A process for comprising the steps of:
Process for removing marble rock without compromising the strength factors of the rock.

5. The invention of claim 4 wherein the types of marble rock an the removal of rock from specific location so that it does not cause stress on the said rock. This process keeps the unique strength factors in tact.
